(19) United States
(12) Patent Application Publication
(10) Pub. No.: US 2026/0111673 A1
(43) Pub. Date: Apr. 23, 2026

(54) SEMANTIC RETRIEVAL BASED ON MULTIPLE KNOWLEDGE DOMAINS

(71) Applicant: Walmart Apollo, LLC, Bentonville, AR (US)

(72) Inventors: Zhaodong Wang, Mountain View, CA (US); Md Omar Faruk Rokon, Santa Clara, CA (US); Weizhi Du, San Jose, CA (US); Yanbing Xue, Sunnyvale, CA (US); Bin Lin, Fresh Meadows, NY (US); Musen Wen, Mountain View, CA (US); Kuang-chih Lee, Fremont, CA (US)

(73) Assignee: Walmart Apollo, LLC, Bentonville, AR (US)

(21) Appl. No.: 18/920,935

(22) Filed: Oct. 20, 2024

(51) Int. Cl. G06F 40/30; G06F 16/33

(52) U.S. Cl. CPC G06F 40/30; G06F 16/3347

(57) ABSTRACT

Examples relate to semantic retrieval. A language model can be pretrained to predict categorical labels from categorical data. Parameters from the language model, as pretrained, are transferred into a two-tower network model. Pairwise training data is constructed from multiple knowledge domains. Embedding pairs are generated using the two-tower network model based on the pairwise training data. The two-tower network model is tuned for semantic retrieval based on the embedding pairs.

### TECHNICAL FIELD

This disclosure relates generally to semantic retrieval based on multiple knowledge domains.

### BACKGROUND

Search engines generally input search queries and output search results. The results often include sponsored and non-sponsored items. Search engines are generally designed to provide some level of understanding of the meaning and/or context of search queries and the items that can be output in the search results. Developing robust semantic retrieval approaches for search engines can be a challenge.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for semantic retrieval based on multiple knowledge domains, according to an embodiment;

FIG. 4 illustrates flow chart for a model training pipeline for semantic retrieval, according to an embodiment;

FIG. 5 illustrates flow chart for a multi-domain dynamic optimizer training pipeline for training the multi-domain dynamic optimizer of FIG. 4;

FIG. 6 illustrates flow chart for a service pipeline for retrieval of a list of items based on a search query, according to an embodiment; and

FIG. 7 illustrates a flow chart for a method of semantic retrieval based on multiple knowledge domains, according to another embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.05 second, 0.1 second, 0.02 second, 0.5 second, one second, or two seconds.

### DETAILED DESCRIPTION

Various embodiments include a system including a processor and a non-transitory computer-readable medium storing computing instructions that, when executed on the processor, cause the processor to perform certain operations. The operations can include pretraining a language model to predict categorical labels from categorical data. The operations also can include transferring parameters from the language model, as pretrained, into a two-tower network model. The operations additionally can include constructing pairwise training data from multiple knowledge domains. The operations further can include generating embedding pairs using the two-tower network model based on the pairwise training data. The operations additionally can include tuning the two-tower network model for semantic retrieval based on the embedding pairs.

A number of embodiments include a computer-implemented method. The method can include pretraining a language model to predict categorical labels from categorical data. The method also can include transferring parameters from the language model, as pretrained, into a two-tower network model. The method additionally can include constructing pairwise training data from multiple knowledge domains. The method further can include generating embedding pairs using the two-tower network model based on the pairwise training data. The method additionally can include tuning the two-tower network model for semantic retrieval based on the embedding pairs. The method further can include receiving a search query from a user. The method additionally can include generating an item retrieval list for the search query based on query embedding vectors and item embedding vectors generated by the two-tower network model, as tuned.

Additional embodiments include a non-transitory computer-readable medium storing computing instructions that, when executed on a processor, cause the processor to perform certain operations. The operations can include pretraining a language model to predict categorical labels from categorical data. The categorical labels can include item types. The operations can include transferring parameters from the language model, as pretrained, into a two-tower network model. The operations also can include constructing pairwise training data from multiple knowledge domains. The operations additionally can include generating embedding pairs using the two-tower network model based on the pairwise training data. The operations further can include tuning the two-tower network model for semantic retrieval based on the embedding pairs.

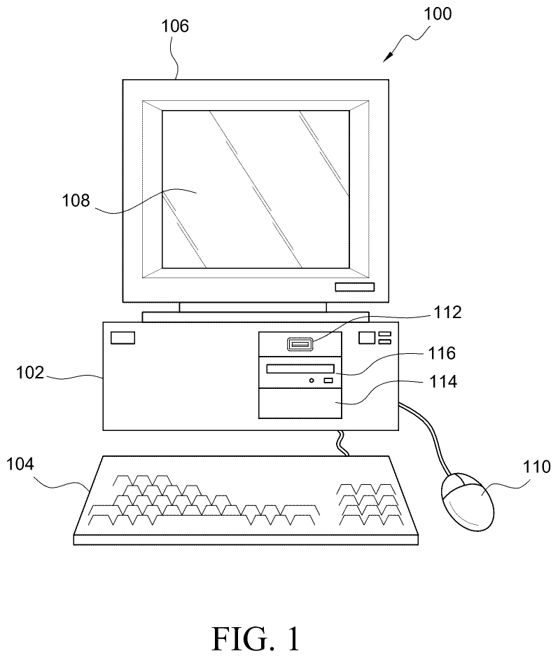

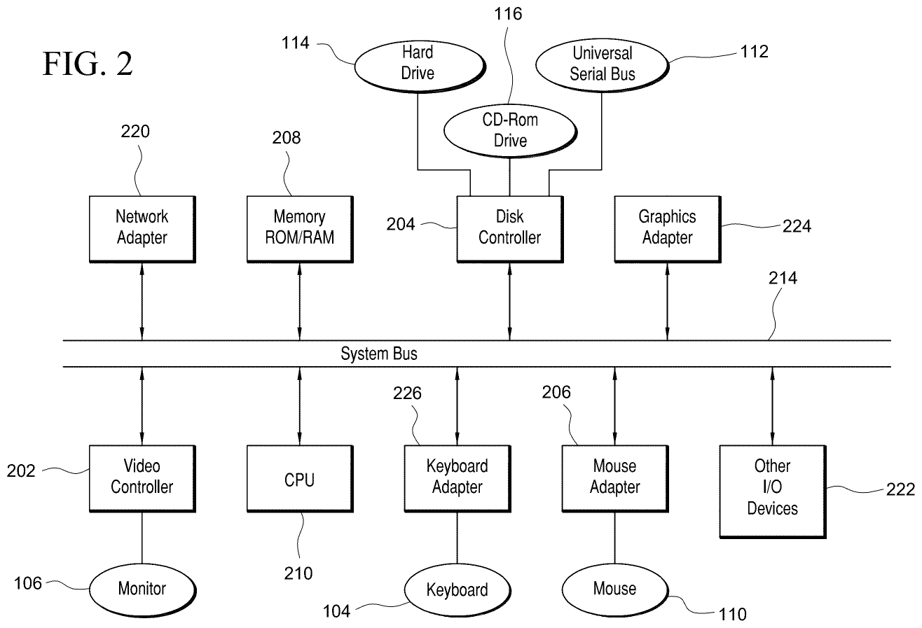

Turning to the drawings, FIG. 1 illustrates an embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random-access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Example operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further examples of operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general-purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

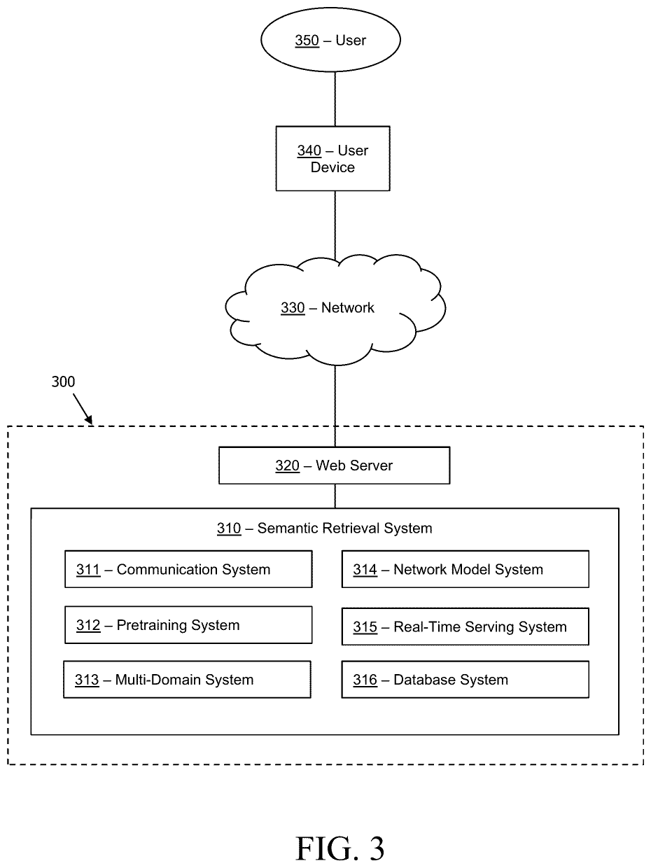

Turning ahead in the drawings, FIG. 3 illustrates a block diagram of a system 300 that can be employed for semantic retrieval based on multiple knowledge domains, according to an embodiment. System 300 is merely an example, and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include a semantic retrieval system 310 and/or a web server 320. Generally, system 300 can be implemented with hardware and/or software, as described herein.

Semantic retrieval system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host semantic retrieval system 310 and/or web server 320.

In some embodiments, web server 320 can be in data communication through a network 330 with one or more user devices, such as a user device 340. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can be a web server that hosts a website, or provides a server that interfaces with an application (e.g., a mobile application), for user device 340, which can allow users (e.g., 350) to search for items (e.g., products), to add items to an electronic cart, and/or to purchase items, and/or or other suitable activities, or to interface with and/or configure semantic retrieval system 310.

In some embodiments, an internal network that is not open to the public can be used for communications between semantic retrieval system 310 and web server 320 within system 300. Accordingly, in some embodiments, semantic retrieval system 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand.

Examples of mobile devices can include (i) an iPod®, iPhone®, iTouch®, iPad®, MacBook® or similar product by Apple Inc. of Cupertino, California, United States of America, and/or (ii) a Galaxy™ or similar product by the Samsung Group of Samsung Town, Seoul, South Korea. Further, in the same or different embodiments, a mobile device can include an electronic device configured to implement the iPhone® operating system by Apple Inc. of Cupertino, California, United States of America, the Android™ operating system developed by the Open Handset Alliance, or another suitable operating system.

In many embodiments, semantic retrieval system 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to semantic retrieval system 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of semantic retrieval system 310 and/or web server 320. In a similar manner, the processors and/or the non-transitory computer-readable media can be local and/or remote to each other.

Meanwhile, in many embodiments, semantic retrieval system 310 and/or web server 320 also can be configured to communicate with one or more databases, such as a database system 316. The one or more databases can include an item database that contains information about items, products, or SKUs (stock keeping units), for example, among other information, as described below in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit, or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s).

Examples of database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, semantic retrieval system 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Examples of PAN protocol(s) can include Bluetooth, Zigbee, Wireless Universal Serial Bus (USB), Z-Wave, etc.; examples of LAN and/or WAN protocol(s) can include Institute of Electrical and Electronic Engineers (IEEE) 802.3 (also known as Ethernet), IEEE 802.11 (also known as WiFi), etc.; and examples of wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, examples of communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further examples of communication hardware can include wireless communication hardware including, for example, one or more radio transceivers, one or more infrared transceivers, etc. Additional examples of communication hardware can include one or more networking components (e.g., modulator-demodulator components, gateway components, etc.).

In many embodiments, semantic retrieval system 310 can include a communication system 311, a pretraining system 312, a multi-domain system 313, a network model system 314, a real-time serving system 315, and/or database system 316. In many embodiments, the systems of semantic retrieval system 310 can be modules of computing instructions (e.g., software modules) stored at non-transitory computer readable media that operate on one or more processors. In other embodiments, the systems of semantic retrieval system 310 and/or web server 320 can be implemented in hardware. Additional details regarding the systems of semantic retrieval system 310 are described below.

Semantic retrieval systems aim to understand the meaning and context behind user queries to provide more relevant and accurate results. Traditional keyword-based search methods often struggle to capture the nuanced intent of users, leading to suboptimal search experiences. Applying these models effectively to specific domains and use cases remains challenging. E-commerce platforms, in particular, face unique challenges in implementing semantic retrieval systems. The vast and diverse nature of product catalogs, sponsored ads, and varied ways users express their search intent, creates a complex landscape for matching queries to relevant items. Additionally, the dynamic nature of e-commerce inventories, sponsor ads, and user preferences can pose challenges.

Multi-domain knowledge integration presents another significant challenge in developing robust semantic retrieval systems. Different knowledge domains, such as general language understanding, domain-specific terminology, and user behavior patterns, all contribute valuable information to the retrieval process. Effectively combining these diverse sources of knowledge in a cohesive and computationally efficient manner is an ongoing area of research and development. Additionally, the real-time nature of modern search systems adds another layer of complexity. Users expect results in real-time, so retrieval systems often seek to process queries and generate relevant recommendations with minimal latency. Balancing the depth of semantic understanding with the speed of retrieval remains a consideration in system design.

In many embodiments, the techniques disclosed herein can provide semantic item retrieval with multi-objective label fusion and real-time serving. In some embodiments, the items can be sponsored ads and/or items (e.g., products). In many embodiments, system 300 can train a Siamese network to predict query and item semantic similarities, and rank items according to decreasing semantic similarities. A knowledge fusion approach can be used, which can fuse labels from multiple sources and human annotations to optimize item relevance. A query-dependent quality-control technique can be used, and the system can be deployed to serving a large number of items per day in production, such as more than a million ads per day.

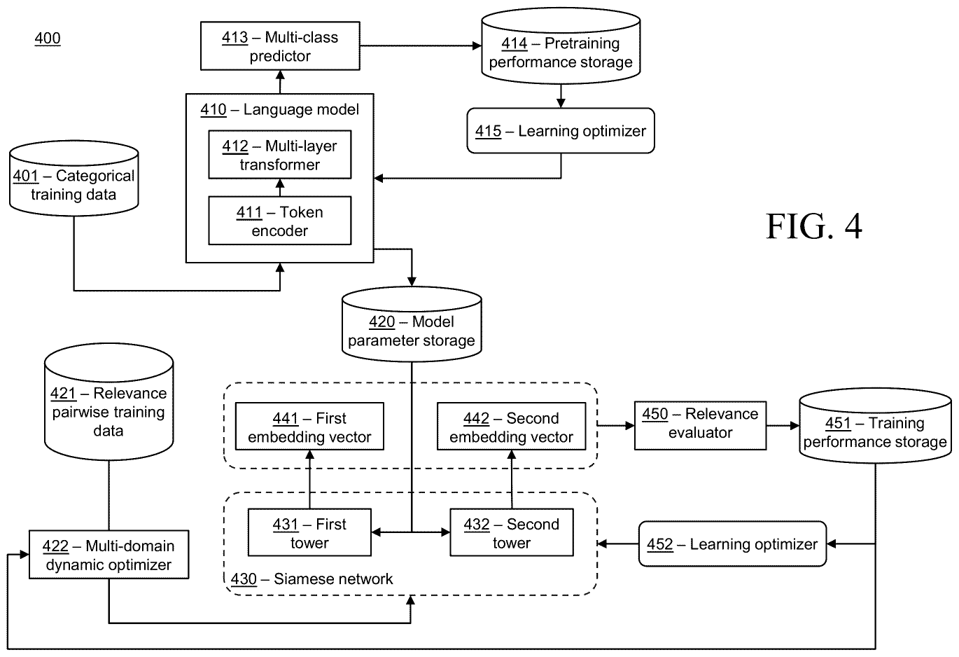

Turning ahead in the drawings, FIG. 4 illustrates flow chart for a model training pipeline 400 for semantic retrieval. Model training pipeline 400 is merely an example and is not limited to the embodiments presented herein. Model training pipeline 400 can be employed in many different embodiments or examples not specifically depicted or described herein. In some embodiments, the procedures, the processes, and/or the activities of model training pipeline 400 can be performed in the order presented. In other embodiments, the procedures, the processes, and/or the activities of model training pipeline 400 can be performed in any suitable order. In still other embodiments, one or more of the procedures, the processes, and/or the activities of model training pipeline 400 can be combined or skipped. In many embodiments, model training pipeline 400 can be implemented using pretraining system 312 (FIG. 3), multi-domain system 313 (FIG. 3, and network model system 314 (FIG. 3). In many embodiments, model training pipeline 400 can pretrain a language model that can be used in a Siamese network model, and the Siamese network model can be fine-tuned across different semantic tasks for improved query-item matching based on semantic relevance.

As shown in FIG. 4, model training pipeline 400 can begin with pretraining a language model 410 using categorical training data 401. Categorical training data 401 can include a diverse range of labeled data points from various domains relevant to semantic retrieval, such as in eCommerce applications, such as product descriptions, user-generated content, search queries, and associated categorical labels. This dataset can include product titles, descriptions, and specifications along with their corresponding category labels, ranging from broad categories to specific subcategories. In some implementations, categorical training data 401 can include hierarchical category structures, allowing language model 410 to learn relationships between parent and child categories. Categorical training data 401 also can include attribute-value pairs associated with products, such as “Color: Red” or “Size: Large”, enabling the model to understand and predict detailed product characteristics.

In some embodiments, language model 410 can include a token encoder 411 and/or a multi-layer transformer 412. Token encoder 411 can process the input data from categorical training data 401, converting it into a format suitable for multi-layer transformer 412. In some implementations, token encoder 411 can tokenize the input text, breaking it down into individual words or subwords, and then map these tokens to numerical representations or embeddings. Token encoder 411 also can handle special tokens such as [CLS] for classification tasks or [September] to separate different segments of input. Additionally, token encoder 411 can incorporate positional encodings to provide the model with information about the relative or absolute position of tokens in the sequence.

In many embodiments, multi-layer transformer 412 can be a BERT (Bidirectional Encoder Representations from Transformers) transformer. In many embodiments, multi-layer transformer 412 can use bidirectional training of a transformer, allowing it to learn contextual relations between words in a text for natural language processing. BERT can pretrained on a large corpus of unlabeled text using unsupervised tasks, such as masked language modeling and next sentence prediction. Pretrained BERT model can then be trained with an additional output layer to create a custom language model. In many embodiments, multi-layer transformer 412 can apply a series of self-attention mechanisms to capture complex relationships within the tokenized input data. In some implementations, it can include multiple stacked transformer blocks, each containing self-attention layers and feed-forward neural networks. Multi-layer transformer 412 can utilize multi-head attention, allowing it to focus on different aspects of the input simultaneously and capture various types of dependencies. This architecture can enable the model to process long-range dependencies effectively, making it well-suited for understanding the context and semantics of the input data.

In many embodiments, multi-class predictor 413 can take the output from multi-layer transformer 412 and generate predictions for categorical labels. In some implementations, multi-class predictor 413 can include one or more fully connected neural network layers, with the final layer using a softmax activation function to produce probability distributions over the possible categories. Multi-class predictor 413 can be designed to handle a large number of potential categories, allowing it to make fine-grained predictions about the nature of the input data. The categorical labels output can be product type, catalog taxonomy, and/or other suitable labels, which can be compared to the labels in categorical training data 401. In many embodiments, data about the pretraining of language model 410, including performance results, can be stored in pretraining performance storage 414.

In many embodiments, model training pipeline 400 can continue to pretrain language model 410 by using a learning optimizer 415 training language model 410 to minimize cross-entropy loss. Learning optimizer 415 can use the data stored in pretraining performance storage 414 to apply cross-entropy optimization techniques to refine language model 410, which can improve the ability of language model 410 to predict categorical labels accurately. Learning optimizer 415 can use a cross-entropy loss function to measure the difference between the predicted probability distribution from multi-class predictor 413 and the true categorical labels from categorical training data 401. In some embodiments, learning optimizer 415 can compute gradients of the loss with respect to the model parameters and use these gradients to update the weights of language model 410 through backpropagation. Learning optimizer 415 can employ techniques such as stochastic gradient descent or adaptive learning rate methods to efficiently minimize the cross-entropy loss. By iteratively adjusting the model parameters to reduce this loss, learning optimizer 415 can train the language model 410 to make increasingly accurate predictions on the categorical training data.

Once the language model 410 has been trained in the pretrain task, its parameters can be stored in model parameter storage 420. These parameters can then be used to initialize the Siamese network 430, which can include two identical subnetworks: a first tower 431 and a second tower 432, which can each be a language model similar to language model 410. This parameter transfer can allow Siamese network 430 to leverage the knowledge gained during the language model pretraining phase. The parameters can include the weights and biases of token encoder 411 and multi-layer transformer 412. For token encoder 411, these parameters can include embedding matrices for converting tokens to vector representations and any positional encoding parameters. The parameters from multi-layer transformer 412 can include weights for the self-attention mechanisms, feed-forward neural networks, and layer normalization components in each transformer block. When transferred to Siamese network 430, these pretrained parameters can be used to initialize the weights of first tower 431 and second tower 432, which can allow for faster training convergence and better performance on the semantic retrieval task.

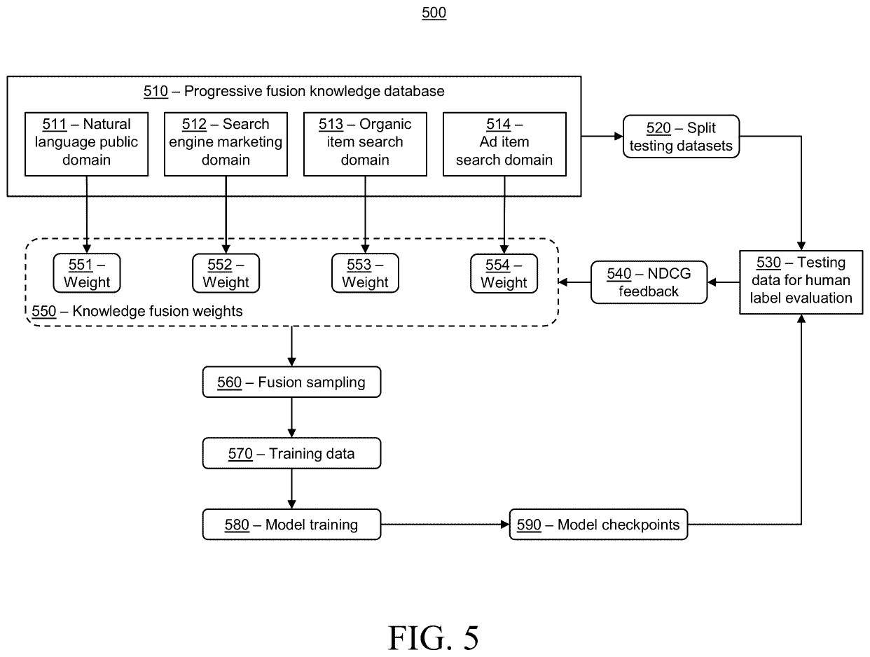

In many embodiments, Siamese network 430 can receive input from relevance pairwise training data 421, which first can be constructed by a multi-domain dynamic optimizer 422. In many embodiments, multi-domain dynamic optimizer 422 can dynamically construct the pair-wise training data from multiple knowledge domains, such as shown in FIG. 5 and described below. For example, pairwise data in relevance pairwise training data 421 can be [search query]-[ad item title]. In many embodiments, multi-domain dynamic optimizer 422 can help balance and integrate information from multiple knowledge domains, which can improving the ability of the language model in towers 431-432 to handle diverse types of queries and items.

In many embodiments, first tower 431 and second tower 432 of Siamese network 430 can generate a first embedding vector 441 and a second embedding vector 442, respectively. Embedding vectors 441-442 can be embedding vector pairs that represent the semantic content of queries and items, respectively, in a high-dimensional space, allowing for efficient similarity comparisons. For example, first tower 431 can input the query portion of the pairwise data, and second tower 432 can input the ad item title portion of the pairwise data. Embedding vectors 441-442 can then be evaluated by a relevance evaluator 450, which can assess and benchmark the performance of the embeddings (e.g., 441-442) generated by Siamese network 430 across multiple domain sets. The results of this evaluation can be stored in a training performance storage 451. This storage may keep track of various metrics that indicate how well the model is performing on the task of semantic retrieval. A learning optimizer 452 can apply optimization using cosine-similarity loss to refine Siamese network 430 based on the evaluation results. The optimized parameters can then be backpropagated into Siamese network 430 and/or multi-domain dynamic optimizer 422, which can create a continuous improvement loop in the training pipeline. This iterative process of training, evaluation, and optimization can allow Siamese network 430 to progressively improve its performance on semantic retrieval tasks.

In many embodiments, the structure of model training pipeline 400 can provide task-progression leaning that integrates multiple tasks into an architectural framework using a common language model (e.g., language model 410, first tower 431, second tower 432) that is optimized for multiple domains. In some implementations, model training pipeline 400 can be executed multiple times with different hyperparameters or training data configurations to determine the optimal model. In some implementations, model training pipeline 400 can incorporate techniques such as early stopping or learning rate scheduling to further improve training efficiency and model performance.

Turning ahead in the drawings, FIG. 5 illustrates flow chart for a multi-domain dynamic optimizer training pipeline 500 for training multi-domain dynamic optimizer 422 (FIG. 4). Multi-domain dynamic optimizer training pipeline 500 is merely an example and is not limited to the embodiments presented herein. Multi-domain dynamic optimizer training pipeline 500 can be employed in many different embodiments or examples not specifically depicted or described herein. In some embodiments, the procedures, the processes, and/or the activities of multi-domain dynamic optimizer training pipeline 500 can be performed in the order presented. In other embodiments, the procedures, the processes, and/or the activities of multi-domain dynamic optimizer training pipeline 500 can be performed in any suitable order. In still other embodiments, one or more of the procedures, the processes, and/or the activities of multi-domain dynamic optimizer training pipeline 500 can be combined or skipped. In many embodiments, multi-domain dynamic optimizer training pipeline 500 can be implemented using multi-domain system 313 (FIG. 3). In many embodiments, multi-domain dynamic optimizer training pipeline 500 can optimize the construction of pairwise training data from multiple knowledge domains for improved query-item matching based on semantic relevance.

As shown in FIG. 5, multi-domain dynamic optimizer training pipeline 500 can use a progressive fusion knowledge database 510. In some embodiments, progressive fusion knowledge database 510 can include data from various different domains relevant to semantic retrieval in eCommerce applications. These domains can include a natural language public domain 511, which can contain general language understanding data; a search engine marketing domain 512, which can include search engine marketing (SEM) data from one or more search engines; an organic item search domain 513, which can contain data from natural search queries and results; an ad item search domain 514, which can include data specific to sponsored or advertised items; and/or other suitable domains. The domains progressing from 511 to 514 can go from broad and general knowledge to narrow and specialized knowledge. This multi-domain approach can leverage diverse sources of information for more comprehensive semantic understanding, to provide general semantic knowledge as well as specific eCommerce retailer knowledge.

In many embodiments, multi-domain dynamic optimizer training pipeline 500 can include a set of knowledge fusion weights 550, such as weights 551-554, each corresponding to a domain (e.g., 511-514, respectively). In some embodiments, knowledge fusion weights 550 can be initially set based on domain expertise or historical performance data of each knowledge domain. Knowledge fusion weights 550 can represent the relative importance of each domain in the overall training process.

In many embodiments, multi-domain dynamic optimizer training pipeline 500 can including splitting the data from progressive fusion knowledge database 510 into testing datasets 530 (e.g., one for each domain) for human evaluation. In some embodiments, human evaluation can be done through crowdsourcing and/or through experts. Testing datasets 530 can be used to provide NDCG (Normalized Discounted Cumulative Gain) feedback 540 into knowledge fusion weights 550. NDCG can measure ranking quality, with a focus on ranking highly relevant items at the top. For example, NDCG feedback xᵢ for a domain i can be integrated into the weight wᵢ for domain i using the following formula, in which exp is the exponential function based on Euler's number:

$${w}_{i} = \frac{1}{1 + exp ( 10 {x}_{i} - 5 )}$$

In some implementations, knowledge fusion weights 550 can be dynamically adjusted using machine learning techniques, such as reinforcement learning or Bayesian optimization, based on NDCG feedback 540 from testing datasets 530. In some embodiments, knowledge fusion weights 550 can be incrementally modified to maximize overall performance across the domains. These weights (e.g., 551-554) can feed into a fusion sampling 560, which can generate training data 570 (which can be similar or identical to relevance pairwise training data 421 (FIG. 4). In many embodiments, fusion sampling can be performed from the different domains according to their assigned weights (e.g., 551-554). Training data 570 can then be used in a model training 580, which can be similar or identical to training of Siamese network 430 (FIG. 4) described above. Model checkpoints 590 can represent snapshots of the model at different stages of training. Model checkpoints 590 can be fed back into the testing datasets 530 for human evaluation, to evaluate performance of the learning, the weights can be updated based on such evaluation, creating a feedback loop. This feedback loop can allow for continuous optimization of the model, as the performance on the testing data can inform adjustments to the knowledge fusion weights and sampling strategy.

In many embodiments, the structure of multi-domain dynamic optimizer training pipeline 500 can provide a flexible and adaptive approach to training semantic retrieval models. By dynamically adjusting the contributions of different knowledge domains, the system can balance and optimize its performance across a wide range of query types and item categories from multiple knowledge domains. Combined with human evaluation, this approach can result in a more robust and versatile semantic retrieval system, capable of handling the diverse and evolving nature of eCommerce search queries and ad items.

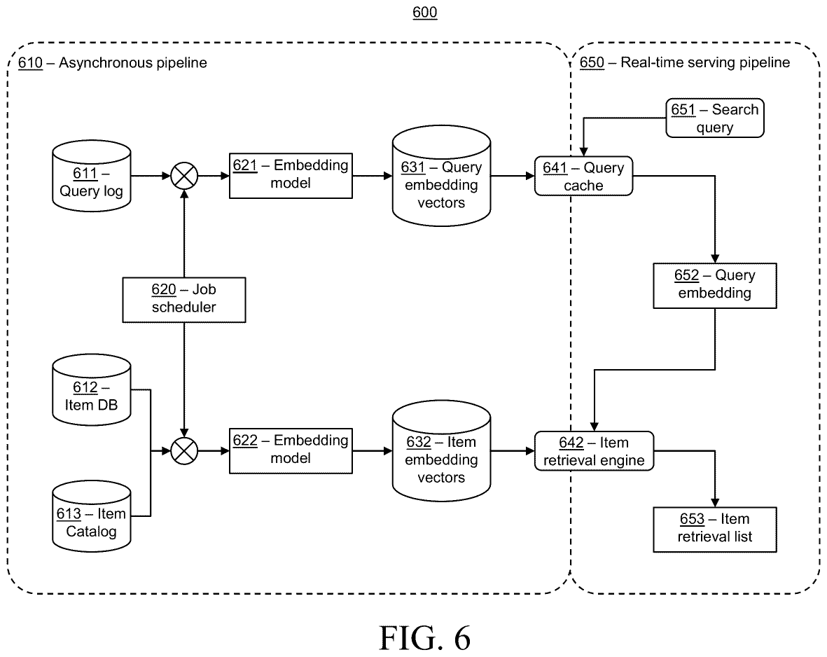

Turning ahead in the drawings, FIG. 6 illustrates flow chart for a service pipeline 600 for retrieval of a list of items (e.g., ad items) based on a search query. Service pipeline 600 is merely an example and is not limited to the embodiments presented herein. Service pipeline 600 can be employed in many different embodiments or examples not specifically depicted or described herein. In some embodiments, the procedures, the processes, and/or the activities of service pipeline 600 can be performed in the order presented. In other embodiments, the procedures, the processes, and/or the activities of service pipeline 600 can be performed in any suitable order. In still other embodiments, one or more of the procedures, the processes, and/or the activities of service pipeline 600 can be combined or skipped. In many embodiments, service pipeline 600 can be implemented using real-time serving system 315 (FIG. 3). In many embodiments, service pipeline 600 can provide high-throughput real-time semantic retrieval for improved query-item matching based on semantic relevance.

As shown in FIG. 6, service pipeline 600 can include an asynchronous pipeline 610 and a real-time serving pipeline 650. Asynchronous pipeline 610 can process and prepare data for efficient real-time retrieval, and real-time serving pipeline 650 can handle incoming search queries and generate item retrieval lists in real-time after receiving the search queries.

In many embodiments, asynchronous pipeline 610 can use data sources, such as a query log 611, an item database 612, and/or an item catalog 613. Query log 611 can contain historical search queries submitted by users. Item database 612 can store information about individual items, such as titles, attributes, descriptions, and/or metadata. Item catalog 613 can contain hierarchical category information and relationships between different items. In many embodiments, the items can be sponsored ad items.

In many embodiments, asynchronous pipeline 610 can include a job scheduler 620, which can coordinate the processing of data through embedding model 621 and embedding model 622. Job scheduler 620 can manage the workflow of the data processing, and can run periodically, such as hourly, daily, weekly, etc., and/or as triggered by changes or satisfying a threshold number of changes. Embedding model 621 can process query data from query log 611, generating vector representations that capture the semantic meaning of user queries. Embedding model 622 can process item data from item database 612 and/or item catalog 613, creating vector representations that encode the semantic properties of items. Embedding models 621 and/or 622 can be similar or identical to the trained language models in towers 431-432 (FIG. 4), as trained by model training pipeline 400 (FIG. 4).

The output of embedding model 621 can query embedding vectors 631, which can be stored in a database, and/or the output of embedding model 622 can be item embedding vectors 632, which can be stored in a database. These embedding vectors (e.g., 631-632) can serve as compact, semantically rich representations of queries and items, enabling efficient similarity comparisons in real-time serving pipeline 650. For example, query embedding vector 631 can be stored in a query cache 641 for real-time retrieval of query embeddings, and/or item embedding vectors 632 can be used in an item retrieval engine 642 for real-time retrieval of items (e.g., ad items) based on a query embedding.

In many embodiments, real-time serving pipeline 650 can involve obtaining a search query 651, which can be fed as input into query cache 641. Query cache 641 can store frequently used query embeddings, allowing for real-time retrieval without or with limited computation. This caching mechanism can significantly reduce latency for common queries. Search query 651 can be processed through query cache 641 to generate a query embedding 652. In some embodiments, if the query embedding is not found in the cache, it can be computed on-the-fly using the same embedding model (e.g., 621) as in the asynchronous pipeline.

In many embodiments, query embedding 652, along with item embedding vectors 632, as precomputed in asynchronous pipeline 610, can be used by item retrieval engine 642 in real-time serving pipeline 650 to produce an item retrieval list 653 in real-time. In many embodiments, the number of items in item retrieval list 653 can be predetermined, e.g., 5, 10, 20, 50, 128, 256, or another suitable number of items, and/or configurable by an operator. In many embodiments, item retrieval engine 642 can employ efficient similarity search algorithms, such as cosine-similarity, to quickly identify items whose embeddings are most similar to the query embedding. This approach can allow for semantic matching that goes beyond simple keyword matching, capturing the intent and context of the search query. This pipeline can leverage the semantic understanding developed during the training phase (e.g., as described above in connection with FIG. 4) to provide relevant and contextually appropriate results to users in real-time. Based on testing, in some examples, performance of these improved models showed relevance gains of approximately 17% in the context of sponsored ad items, as evidenced by increase performance in click-through-rates, actually viewed ads, and ad-spend compared to traditional techniques.

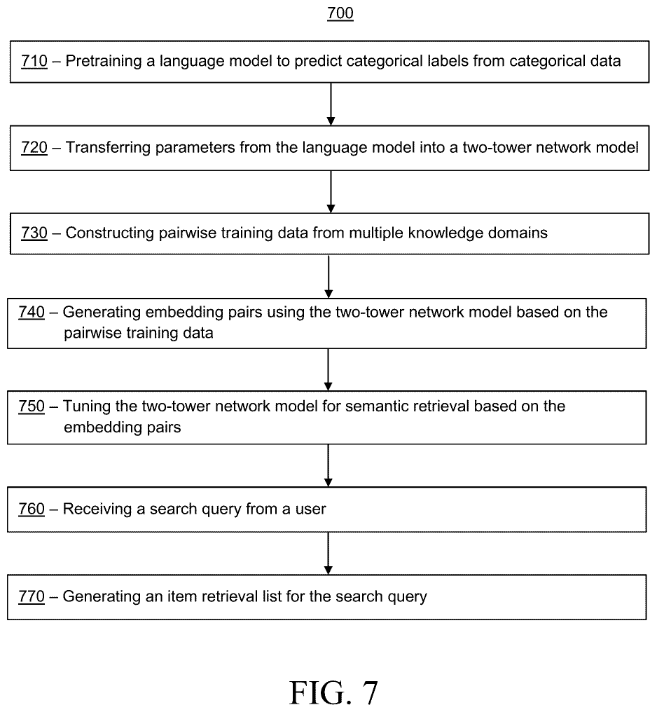

Turning ahead in the drawings, FIG. 7 illustrates a flow chart for a method 700 of semantic retrieval based on multiple knowledge domains, according to another embodiment. Method 700 is merely an example, and the method is not limited to the embodiments presented herein. Method 700 can be employed in many different embodiments or examples not specifically depicted or described herein. In some embodiments, the procedures, the processes, and/or the activities of method 700 can be performed in the order presented. In other embodiments, the procedures, the processes, and/or the activities of method 700 can be performed in any suitable order. In still other embodiments, one or more of the procedures, the processes, and/or the activities of method 700 can be combined or skipped.

In many embodiments, system 300 (FIG. 3), semantic retrieval system 310 (FIG. 3), and/or web server 320 (FIG. 3) can be suitable to perform method 700 and/or one or more of the activities of method 700. In these or other embodiments, one or more of the activities of method 700 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1). In some embodiments, method 700 and other activities in method 700 can include using a distributed network including distributed memory architecture to perform the associated activity. This distributed architecture can reduce the impact on the network and system resources to reduce congestion in bottlenecks while still allowing data to be accessible from a central location.

Referring to FIG. 7, method 700 can include an activity 710 of pretraining a language model to predict categorical labels from categorical data. Pretraining the language model can be similar or identical to elements 401-420 of FIG. 4, as described above. In many embodiments, the categorical labels can include item types. In many embodiments, pretraining the language model can include minimize a cross-entropy loss, such as by using a learning optimizer (e.g., 415 (FIG. 4)). In many embodiments, activity 710 can be performed at least in part by pretraining system 312 (FIG. 3).

In many embodiments, method 700 also can include an activity 720 of transferring parameters from the language model, as pretrained, into a two-tower network model. The two-tower model can be similar or identical to Siamese network 430 (FIG. 4). In many embodiments, the parameters from the language model can be stored in model parameter storage (e.g., 420 (FIG. 4)), and the two-tower model can retrieve the parameters from the model parameter storage. In other embodiments, a synchronization process can be used to transfer the parameters. In some embodiments, the two-tower network model can include a first tower for analyzing queries and a second tower for analyzing items. The first tower can be similar or identical to first tower 431 (FIG. 4), and/or the second tower can be similar or identical to second tower 432 (FIG. 4).

In many embodiments, method 700 additionally can include an activity 730 of constructing pairwise training data from multiple knowledge domains. In many embodiments, activity 730 can include using a multi-domain dynamic optimizer that is trained with dynamic weight learning from a balance of the multiple knowledge domains. The multi-domain dynamic optimizer can be similar or identical to multi-domain dynamic optimizer 422 (FIG. 4), which can be trained similarly as shown in FIG. 5 and described above. In many embodiments, activity 730 can be performed at least in part by multi-domain system 313 (FIG. 3).

In many embodiments, method 700 further can include an activity 740 of generating embedding pairs using the two-tower network model based on the pairwise training data. The embedding pairs can be similar or identical to embedding vectors 441-442 (FIG. 4). In many embodiments, activity 740 can be performed at least in part by network model system 314 (FIG. 3).

In many embodiments, method 700 additionally can include an activity 750 of tuning the two-tower network model for semantic retrieval based on the embedding pairs. In many embodiments, tuning the two-tower network model can be similar or identical to elements 421-452 of FIG. 4, as described above. In many embodiments, tuning the two-tower network model further can include optimizing a cosine similarity distance loss, such as by using a learning optimizer (e.g., 452 (FIG. 4).

In many embodiments, method 700 further can include an activity 760 of receiving a search query from a user. Search query can be similar or identical to search query 651 (FIG. 6).

In many embodiments, method 700 additionally can include an activity 770 of generating an item retrieval list for the search query based on one or more query embedding vectors and item embedding vectors generated by the two-tower network model, as tuned. The tuned two-tower network model can be similar or identical to embedding models 621-622 (FIG. 6). The query embedding vectors can be similar or identical to query embedding vectors 631 (FIG. 3) and/or query embedding 652 (FIG. 6). The item embedding vectors can be similar or identical to item embedding vectors 632 (FIG. 6), which can be used by an item retrieval engine (e.g., 642 (FIG. 6), based on query embedding 652 (FIG. 6), to generate an item retrieval list. In many embodiments, the items in item retrieval list can be output to the user as part of the response to the search query.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although semantic retrieval based on multiple knowledge domains has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-7 may be modified, and that the foregoing discussion of certain of these embodiments does not necessarily represent a complete description of all possible embodiments. For example, one or more of the procedures, processes, or activities of FIGS. 4-7 may include different procedures, processes, and/or activities and be performed by many different modules, in many different orders, and/or one or more of the procedures, processes, or activities of FIGS. 4-7 may include one or more of the procedures, processes, or activities of another different one of FIGS. 4-7. As another example, the systems within system 300 (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a processor; and
a non-transitory computer-readable medium storing computing instructions that, when executed on the processor, cause the processor to perform operations comprising:
pretraining a language model to predict categorical labels from categorical data;
transferring parameters from the language model, as pretrained, into a two-tower network model;
constructing pairwise training data from multiple knowledge domains;
generating embedding pairs using the two-tower network model based on the pairwise training data; and
tuning the two-tower network model for semantic retrieval based on the embedding pairs.

2. The system of claim 1, wherein the categorical labels comprise item types.

3. The system of claim 1, wherein the operations further comprise, after tuning the two-tower network model:
receiving a search query from a user; and
generating an item retrieval list for the search query based on query embedding vectors and item embedding vectors generated by the two-tower network model, as tuned.

4. The system of claim 1, wherein pretraining the language model comprises minimize a cross-entropy loss.

5. The system of claim 1, wherein the two-tower network model comprises a first tower for analyzing queries and a second tower for analyzing items.

6. The system of claim 1, wherein tuning the two-tower network model further comprises optimizing a cosine similarity distance loss.

7. The system of claim 1, wherein constructing the pairwise training data comprises using a multi-domain dynamic optimizer.

8. The system of claim 7, wherein the multi-domain dynamic optimizer is trained with dynamic weight learning from a balance of the multiple knowledge domains.

9. A computer-implemented method comprising:
pretraining a language model to predict categorical labels from categorical data;
transferring parameters from the language model, as pretrained, into a two-tower network model;
constructing pairwise training data from multiple knowledge domains;
generating embedding pairs using the two-tower network model based on the pairwise training data;
tuning the two-tower network model for semantic retrieval based on the embedding pairs;
receiving a search query from a user; and
generating an item retrieval list for the search query based on query embedding vectors and item embedding vectors generated by the two-tower network model, as tuned.

10. The computer-implemented method of claim 9, wherein the categorical labels comprise item types.

11. The computer-implemented method of claim 9, wherein pretraining the language model comprises minimize a cross-entropy loss.

12. The computer-implemented method of claim 9, wherein the two-tower network model comprises a first tower for analyzing queries and a second tower for analyzing items.

13. The computer-implemented method of claim 9, wherein tuning the two-tower network model further comprises optimizing a cosine similarity distance loss.

14. The computer-implemented method of claim 9, wherein constructing the pairwise training data comprises using a multi-domain dynamic optimizer that is trained with dynamic weight learning from a balance of the multiple knowledge domains.

15. A non-transitory computer-readable medium storing computing instructions that, when executed on a processor, cause the processor to perform operations comprising:
pretraining a language model to predict categorical labels from categorical data, wherein the categorical labels comprise item types;
transferring parameters from the language model, as pretrained, into a two-tower network model;
constructing pairwise training data from multiple knowledge domains;
generating embedding pairs using the two-tower network model based on the pairwise training data; and
tuning the two-tower network model for semantic retrieval based on the embedding pairs.

16. The non-transitory computer-readable medium of claim 15, wherein the operations further comprise, after tuning the two-tower network model:
receiving a search query from a user; and
generating an item retrieval list for the search query based on query embedding vectors and item embedding vectors generated by the two-tower network model, as tuned.

17. The non-transitory computer-readable medium of claim 15, wherein pretraining the language model comprises minimize a cross-entropy loss.

18. The non-transitory computer-readable medium of claim 15, wherein:
the two-tower network model comprises a first tower for analyzing queries and a second tower for analyzing items.

19. The non-transitory computer-readable medium of claim 15, wherein:
tuning the two-tower network model further comprises optimizing a cosine similarity distance loss.

20. The non-transitory computer-readable medium of claim 15, wherein constructing the pairwise training data comprises using a multi-domain dynamic optimizer that is trained with dynamic weight learning from a balance of the multiple knowledge domains.
